(19) United States
(12) Patent Application Publication
(10) Pub. No.: US 2023/0091965 A1
(43) Pub. Date: Mar. 23, 2023

(54) SYSTEMS AND METHODS FOR APPLICATION-BASED MANAGEMENT OF TRANSACTIONS

(71) Applicant: JPMORGAN CHASE BANK, N.A., New York, NY (US)

(72) Inventors: Timothy CHEUNG, Carshalton (GB); Aaron LINDSAY, London (GB); Rebecca MCLENNAN, Edinburgh (GB)

(21) Appl. No.: 17/932,534

(22) Filed: Sep. 15, 2022

Related U.S. Application Data
(60) Provisional application No. 63/245,586, filed on Sep. 17, 2021.

(51) Int. Cl. G06Q 20/40; G06F 16/23

(52) U.S. Cl. CPC G06Q 20/4016; G06F 16/2379

(57) ABSTRACT

Systems and methods for application-based management of transactions are disclosed. In accordance with aspects, a method may include receiving, at a transaction management service, a received transaction including a plurality of data parameters associated with the received transaction; generating, by the transaction management service, a transaction challenge record including the plurality of data parameters, a party key and a challenge identifier; transmitting a notification to a user device including the challenge identifier; receiving, from the user device, a validation communication that validates the received transaction and includes the challenge identifier; determining customer context information based on the challenge identifier and the party key; generating, by the transaction management service, service options based on the customer context information; transmitting, by the transaction management service, the service options to the user device; and receiving, at the transaction management service, instructions with respect to the received transaction based on the service options.

### RELATED APPLICATIONS

This application is related to U.S. Patent Application Ser. No. 63/245,586, filed Sep. 17, 2021, and entitled SYSTEMS AND METHODS FOR APPLICATION-BASED MANAGEMENT OF TRANSACTIONS, the disclosure of which is hereby incorporated by reference in its entirety.

### BACKGROUND

### 1. Field of the Invention

Aspects generally relate to application-based management of transactions.

### 2. Description of the Related Art

Consumer transactions charged to credit cards/accounts are ubiquitous in today's consumer economy. Payment processors (such as Mastercard, Visa, etc.) implement and maintain networks and systems configured to capture and process transaction details from merchants. Financial institutions issue credit cards/accounts to consumers to be used in consumer transactions. Traditionally, consumers indicate to a merchant the card/account to be used in a consumer transaction.

### SUMMARY

In some aspects, the techniques described herein relate to a method including: receiving, at a transaction management service, a received transaction, wherein the received transaction includes a plurality of data parameters associated with the received transaction; generating, by the transaction management service, a transaction challenge record, wherein the transaction challenge record includes the plurality of data parameters, a party key and a challenge identifier; transmitting a notification to a user device, wherein the notification includes the challenge identifier; receiving, from the user device, a validation communication, wherein the validation communication validates the received transaction and includes the challenge identifier; determining customer context information based on the challenge identifier and the party key; generating, by the transaction management service, service options based on the customer context information; transmitting, by the transaction management service, the service options to the user device; and receiving, at the transaction management service, instructions with respect to the received transaction based on the service options.

In some aspects, the techniques described herein relate to a method, including: executing, by the transaction management service, a first query against a customer information database, wherein the first query includes one of the plurality of data parameters as a lookup key, and wherein the first query returns the party key;

In some aspects, the techniques described herein relate to a method, including: persisting the transaction challenge record in a challenge transaction context database.

In some aspects, the techniques described herein relate to a method, including: executing, by the transaction management service, a second query against the challenge transaction context database, wherein the second query uses the challenge identifier as a lookup parameter and returns the party key.

In some aspects, the techniques described herein relate to a method, including: executing, by the transaction management service, a third query against the customer information database, wherein the third query uses the party key as a lookup parameter and returns customer context information.

In some aspects, the techniques described herein relate to a method, wherein the received transaction is processed by a fraud engine and wherein the fraud engine returns a fraud score to the transaction management service.

In some aspects, the techniques described herein relate to a method, including: generating, by the transaction management sever, a transaction event trigger, wherein the transaction event trigger is based on the transaction challenge record.

In some aspects, the techniques described herein relate to a method, wherein the transaction challenge record and the transaction event trigger include a template ID.

In some aspects, the techniques described herein relate to a method, wherein the transaction management server transmits the transaction event trigger to a communication manager.

In some aspects, the techniques described herein relate to a method, wherein the communication manager formats the notification as specified by the template ID.

In some aspects, the techniques described herein relate to a system, including: a transaction management server executing a transaction management service, wherein the transaction management service is configured to: receive a received transaction, wherein the received transaction includes a plurality of data parameters associated with the received transaction; generate a transaction challenge record, wherein the transaction challenge record includes the plurality of data parameters, a party key and a challenge identifier; transmit a notification to a user device, wherein the notification includes the challenge identifier; receive, from the user device, a validation communication, wherein the validation communication validates the received transaction and includes the challenge identifier; determine customer context information based on the challenge identifier and the party key; generate service options based on the customer context information; transmit the service options to the user device; and receive instructions with respect to the received transaction based on the service options.

In some aspects, the techniques described herein relate to a system, wherein the transaction management service is configured to execute a first query against a customer information database, wherein the first query includes one of the plurality of data parameters as a lookup key, and wherein the first query returns the party key.

In some aspects, the techniques described herein relate to a method, wherein the transaction management service is configured to persist the transaction challenge record in a challenge transaction context database.

In some aspects, the techniques described herein relate to a method, wherein the transaction management service is configured to execute a second query against the challenge transaction context database, wherein the second query uses the challenge identifier as a lookup parameter and returns the party key.

In some aspects, the techniques described herein relate to a method, wherein the transaction management service is configured to execute a third query against the customer information database, wherein the third query uses the party key as a lookup parameter and returns customer context information.

In some aspects, the techniques described herein relate to a non-transitory computer readable storage medium, including instructions stored thereon for facilitating application-based management of transactions, which when read and executed by one or more computers cause the one or more computers to perform steps including: receiving, at a transaction management service, a received transaction, wherein the received transaction includes a plurality of data parameters associated with the received transaction; generating, by the transaction management service, a transaction challenge record, wherein the transaction challenge record includes the plurality of data parameters, a party key and a challenge identifier; transmitting a notification to a user device, wherein the notification includes the challenge identifier; receiving, from the user device, a validation communication, wherein the validation communication validates the received transaction and includes the challenge identifier; determining customer context information based on the challenge identifier and the party key; generating, by the transaction management service, service options based on the customer context information; transmitting, by the transaction management service, the service options to the user device; and receiving, at the transaction management service, instructions with respect to the received transaction based on the service options.

In some aspects, the techniques described herein relate to a non-transitory computer readable storage medium, including the steps of: executing, by the transaction management service, a first query against a customer information database, wherein the first query includes one of the plurality of data parameters as a lookup key, and wherein the first query returns the party key;

In some aspects, the techniques described herein relate to a non-transitory computer readable storage medium, including the steps of: persisting the transaction challenge record in a challenge transaction context database.

In some aspects, the techniques described herein relate to a non-transitory computer readable storage medium, including the steps of: executing, by the transaction management service, a second query against the challenge transaction context database, wherein the second query uses the challenge identifier as a lookup parameter and returns the party key.

In some aspects, the techniques described herein relate to a non-transitory computer readable storage medium including the steps of: executing, by the transaction management service, a third query against the customer information database, wherein the third query uses the party key as a lookup parameter and returns customer context information.

### BRIEF DESCRIPTION OF THE DRAWINGS

FIG. 1 is a block diagram of a system for providing application-based management of transactions, in accordance with aspects.

FIG. 2a and FIG. 2b are sequence diagrams for providing application-based management of transactions, in accordance with aspects.

FIG. 3 is a flow chart for providing application-based management of transactions, in accordance with aspects.

FIG. 4 is a block diagram of a computing device for implementing certain aspects of the present disclosure.

### DETAILED DESCRIPTION

Aspects are directed to application-based management of transactions.

In-app management of consumer transactions can offer advantages to clients of financial institutions in the way of service options provided issuing organizations. Some of the service options include the ability to check the balance on accounts to assure sufficiency of funds before approving a transaction, the option to assign a transaction to a secondary account to provide appropriate funding if a primary or initial account is underfunded, the option to divide a transaction amount among several credit cards/accounts, the option to open new lines of credit to fund the transaction, etc. Service option may also include features such as establishment of a payment plan, a line of credit, etc., at the time of a transaction. There are also security advantages when notification services are combined with merchant authentication. These advantages, however, are technically difficult to implement in conventional payment networks, in part due to the disparate systems and networks of payment processors and corresponding financial institutions that manage issued credit cards/accounts.

Aspects herein may include receiving transaction information at a transaction management service hosted by a transaction management server, and from an access control service hosted by an access control server of a payment processing organization. The payment processing organization may provide a payment processing network, sometimes referred to as a “payment rail network,” or “payment rails.” The access control service may be in operative communication with both the payment processing network and the transaction management service, as described in more detail, herein. The transaction management service may be executed on a transaction management server that is part of a backend infrastructure of an issuing organization. The issuing organization may issue credit cards, credit accounts, and/or other payment products (collectively, “payment products”) to customers of the issuing organization. The various payment products issued by the issuing organization may use the payment processing network of the payment processing organization to request monetary payment from (or make other settlement requests with) the issuing organization. That is, when a transaction constitutes a charge (or credit) against a payment product issued by the issuing organization, the transaction details can be sent from a merchant to the issuing organization via the payment processing network of the payment processing organization.

Upon receiving a payload including transaction information, the transaction management service may initiate a fraud inquiry based on the transaction information. The fraud inquiry may be executed by a fraud detection and prevention server that hosts a fraud engine. A fraud engine may include a machine learning (ML) algorithm that is trained on historic transaction data to predict a likelihood of a fraudulent transaction.

The transaction management service may also request and receive, or retrieve, from a customer information database, a party key. The party key may uniquely identify the customer of the issuing organization that is associated with the payment product referenced in a received transaction (the “initiating customer”). Parameterized data received with the transaction payload may be used as a reverse-lookup key to query a customer database of the issuing organization for the party key. For instance, the payment product identifier (e.g., a credit card/account number) may be used to find the customer of the issuing organization that is associated with the received transaction information in an issuer-maintained customer information database.

Once a party key is identified for the initiating customer, the party key may be used to query a customer information database (which, may be one or more institutional databases maintained by the issuing organization) in order to determine institutional information about the initiating customer. For instance, the party key may be used to determine a number and type of credit cards/accounts that the initiating customer has with the issuing organization. The party key may be used to determine the balance on each of the accounts and credit limit on each of the accounts. The party key may further be used to determine if the initiating customer holds a demand deposit account (DDA) with the issuing organization and what the balance of the DDA is if one is returned. This information may be used to provide the initiating customer with various service options for applying the received transaction monetary amount to the various determined accounts of the initiating customer. The information may be retrieved via one or more database queries using the party key as a lookup parameter in the query. Information retrieved based on a party key is collectively referred to herein as customer context information.

In accordance with aspects, the transaction management service may create a transaction challenge based on the received transaction. A transaction challenge may be stored as a database record, may include a challenge identifier (e.g., a primary key that uniquely identifies the challenge), and may further include information from the received transaction such as a transaction identifier (a “transaction ID) that uniquely identifies the transaction, a credit card/account number that identifies the payment product used in the transaction, a merchant identifier (a “merchant ID”) that uniquely identifies the merchant associated with the transaction, the name of the merchant associated with the transaction, etc. The transaction challenge may also include the party key as a record field. The transaction challenge may be stored in a challenge transaction context database for retrieval.

In accordance with aspects, after (or based on) creation of the transaction challenge, the transaction management service may generate a transaction event trigger based on the transaction challenge record stored in the challenge transaction context database. The transaction event trigger may include some or all of the fields stored with the transaction challenge record. (e.g., the transaction challenge data may be embedded in a transaction event trigger communication or payload). Exemplary transaction event trigger data may include a template identification (template ID—which defines a template for graphical presentation of the transaction event trigger data), a transaction amount, a merchant identification and/or name of the merchant with which the transaction was initiated and an identification or copy of stored the challenge created and by the transaction management service (the challenge ID). A transaction event trigger may additionally include an identifier of the payment product used in the transaction, the amount of the transaction, the currency in which the transaction was conducted, the date and time of the transaction, a unique transaction identifier (a transaction ID), and the merchant's logo. The transaction even trigger may further include a void time that counts down until the received transaction is programmatically declined (e.g., by the transaction management service or by the payment processing organization if there is no received validation). In some aspects, the transaction event trigger data may further include retrieved customer context data.

The transaction management service may send the transaction event trigger including some or all of the associated transaction event data to a communication manager service hosted by a communication server. The communication, or “comm,” manager service may be configured to communicate with a user device of the initiating customer identified by the party key. The comm manager service may be hosted on a comm server and may be configured to communicate the transaction event trigger data in the form of a message or notification (e.g., in the format specified in the communicated template ID) to the user device of the initiating customer. That is, a comm manager may format the transaction event trigger data for graphical and/or textual display to the initiating use.

A notification may also include a prompt (i.e., a challenge question) asking the initiating user to validate the received transaction that is captured and indicated in the notification. That is, the notification may request input from the initiating customer in the form of an approval of the transaction or denial of the transaction, where an approval is a validation of the transaction and indicates that payment on behalf of the initiating customer should be made, and where a denial indicates that the transaction was fraudulently initiated, and payment should not be made.

The notification may be in the form of an SMS message, an email, or another out-of-band communication channel and format. Alternatively, the notification may be communicated via an in-band channel through a corresponding application (e.g., a mobile application) provided by the issuing organization and executing on the user's electronic device. In the latter case, the notification may be configured as a “push” notification. In other aspects, an out-of-band notification may include a “deep link.” In still other aspects, initiating user input with respect to the notification may be generated via a return SMS message or a reply to an email notification. Receipt of the notification and user input may be carried out through any combination of available services, applications, and data transferring techniques or protocols available on the device.

In accordance with aspects, end-user interaction with the notification (e.g., clicking on a deep link in an SMS message or an email, or selecting an application notification in a notification center of a mobile OS interface) may launch a corresponding application (also referred to herein as an “app”) installed on the device that is configured to communicate with the transaction management service, the communication manager, an account balance/ledger service, a credit card/account selection logic/service, or other issuing organization services. Once a corresponding app is launched, communication may be carried out “in-band” between the corresponding app and the transaction management service (or other service) via an API or other suitable application-level communications channel.

In accordance with aspects, upon receipt of a notification, the initiating user may respond to the notification. If the initiating user does not validate the received transaction, then the transaction can be cancelled by the transaction management server. If, however, the user validates the transaction as legitimate, then transaction service options may be presented to the initiating customer. The customer may validate or decline the received transaction by interacting with the notification. A response to the notification may take the form of a binary operator (e.g., 1=validate, 2=decline; or yes=validate, no=decline). The response may be in the format in which the notification was received (i.e., a response to an SMS or email message), or the response may be made through the user interface of a corresponding application executing on a user device.

In the case where the notification includes a deep link or a notification associated with a corresponding user-device application, the deep link of the notification may have the challenge ID embedded in the link or the notification, and the response may include the challenge ID as a parameter along with the initiating customer's response to the challenge question. In other aspects, the challenge ID may be communicated in the notification, and the initiating customer may manually include the challenge ID in the response along with the initiating customer's response to the challenge question.

A response to a notification having a positive validation (i.e., an acceptance) of a received transaction may be sent by the initiating customer to the transaction management service. In some aspects, the response may be in the form of a GET message (e.g., a GET method supported by the hypertext transport protocol (HTTP)), or it may be transmitted in another suitable format and over another suitable protocol. The response may include the validation and the challenge ID as parameterized data, e.g., in a GET method. The transaction management service, upon receiving the transaction validation and the challenge ID may then use the challenge ID as a key to lookup the received transaction context in the challenge transaction context database. The transaction management service may execute a database query requesting the received transaction context information, including the party key.

In aspects where customer context data is retrieved and included in a transaction event trigger (i.e., as transaction event trigger data), the challenge ID received from the user device may be verified as a match against the challenge ID stored in the challenge transaction context database for the given transaction ID. In some aspects, however, a notification may include limited transaction context details in order to limit the size of the notification data to acceptable levels for different formats/protocols (e.g., out-of-band communication channels). In these scenarios, the transaction management service may send a more complete set of transaction details to the app than was sent to the user's device via the notification. For instance, customer context data may be sent to a corresponding application after the initial notification is received. The app may compare the received transaction context details (e.g., the challenge ID) with all or parts of the transaction context details received in the notification to verify that the transaction details sent in the notification match the transaction details sent to the app by the transaction management service. Where customer context data is not sent as part of a transaction even trigger, the challenge ID may further be used to retrieve the party key from the challenge transaction context database and then execute queries, as noted above, in order to retrieve the customer context data. The customer context data can then be communicated to a corresponding application executing on the user device.

Based on the received transaction context data and customer context data (from both, or either, of the notification or the app request/retrieval process), the app may be configured to, e.g., display the merchant associated with the transaction, the transaction amount, a timer indicating a remaining time before the transaction is automatically cancelled (i.e, denied), etc. The app may be further configured to display user input interfaces (e.g., “buttons”), that, when selected/activated by the user approve the transaction and communicate the approval to the transaction management service, or disapprove/deny the transaction and communicate the denial to the transaction manager.

Additionally, user input interfaces may be displayed allowing the end user to indicate that the transaction was not initiated by the end user and requesting that the initial card/account assigned to the transaction be prevented from having the transaction and future transactions applied against it (i.e., locking the card/account). Aspects may further include the ability to activate or reactivate a locked card from within the app.

The app may further be configured to display various service options to the initiating customer. For instance, a corresponding application may be configured to display customer context information such as credit cards/accounts available to the initiating customer along with the accounts' corresponding balances and credit limits to the end user. The app may be further configured to indicate to the end user, based on the amount of the transaction and the available balances of the credit cards/accounts, which cards/accounts are available to process the transaction against (e.g., to charge the transaction amount to). For instance, in the event that the transaction amount is a charge to the consumer, then only cards/accounts with an available balance greater than the transaction amount may be made available for the end user to select as the card/account to process the transaction against. In other aspects, a user may be presented with an option to split the monetary amount associated with the received transaction among two or more of the displayed credit accounts included in the customer context data. Moreover, the app may be configured to allow a user to apply a pay-down amount to a credit account from a DDA account included in the customer context data. In accordance with other aspects, the application may be configured to facilitate in-app setup of new credit accounts, or in-app display, and user selection, of payment plan options (e.g., the ability to distribute and pay a portion of the total transaction amount over a number of payment dates).

Aspects may include the ability to flag a merchant as trusted so that authentication of the merchant is not required for future transaction events from this merchant. For example, along with an approval of the transaction, an in-app option to add the relevant merchant to a trusted list may be presented to the user. Upon selection of the option, a flag may be sent to the transaction management service in the initial approval decision regarding a transaction with the merchant. The transaction management service may, upon receipt of the flag, bypass further notifications to the user regarding any transactions received from the merchant flagged as trusted.

Aspects may include a submission of a decision from the user's device to the transaction management service. The submitted decision may be in the form of a POST request message (e.g., a POST method supported by the hypertext transport protocol (HTTP)), or it may be another suitable format and transmitted over another suitable protocol. Data enclosed in the submission decision may include an approval or a denial of the transaction, the amount of the transaction, an identification of the merchant, a credit card/account to process the transaction against, the challenge, and/or other appropriate data.

The transaction decision may be generated by the user device, in part, based on user input to the app. For example, the app may display to the user selectable prompts that, when interacted with by the user, provide the app with the data to be included in the submitted decision. In-app prompts may include an indication of approval or denial of the transaction and an indication of which credit card/account to process the transaction against.

The transaction management service may receive, from the device, the user's decision regarding the transaction. The transaction management service may send details of the transaction to the fraud detection service for logging, evaluation machine learning, etc. The transaction service may also send details of the transaction to a transaction database configured to store the transaction details for audit purposes, historical recording purposes (e.g., the generation of card/account statement reports), etc. The transaction management service may also send the decision to the access control server of the credit card issuer/processor. The access control server may, then, carry out the transaction, or stop the transaction, based on the data in the transaction decision.

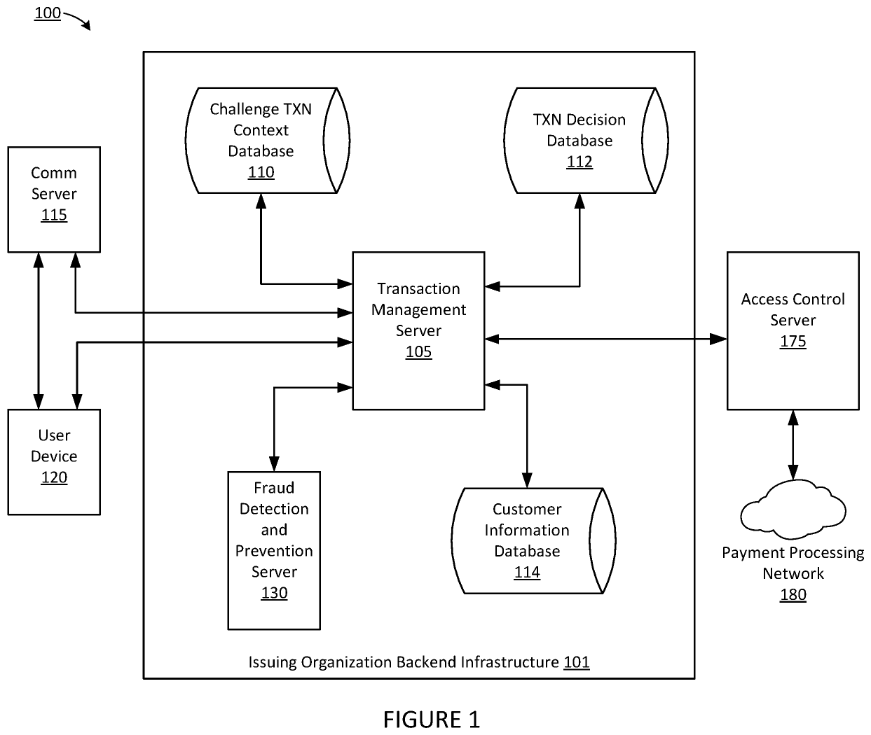

FIG. 1 is a block diagram of a system for providing application-based management of transactions, in accordance with aspects. System 100 includes various components that may be part of an issuing organization's backend technology infrastructure. For instance, system 100 includes transaction management server 105, challenge transaction context database 110, transaction decision database 112, customer information database 114, and fraud detection and prevention server 130 which are each part of issuing organization backend infrastructure 101. Additionally, system 100 includes access control server 175, payment processing network 180, communications server 115, and user device 120.

With continued reference to FIG. 1, access control server 175 may be provided by a payment processing organization and may interface with both payment processing network 180 provided by the payment processing organization and with transaction management server 105 provided by the issuing organization. That is, access control server 175 may act as an interface between the issuing organization and payment processing network 180 provided by the payment processing organization. In other aspects, transaction management server 105 may be interfaced directly with a payment processing network.

Communications server 115 may provide operative communication between transaction management server 105 and user device 120. In accordance with aspects, communications server 115 may be configured to provide out-of-band communications with user device 120, such as SMS messages, email messages, etc. In other aspects, communications server 115 may be configured for operative in-band communication with an application executing on user device 120. Such an application may be provided by the issuing organization. Communications server 115 is depicted outside of issuing organization backend infrastructure 101 (i.e., as a third-party server/service), but in accordance with aspects, may be configured as part of issuing organization backend infrastructure 101.

Transaction management server 105, communications server 115, fraud detection and prevention server 130, and access control server 175 may be configured as central server-computers that host network-based applications and service network requests from client-computers and from other server-computers. Challenge transaction context database 110, transaction decision database 112, and customer information database 114 may be database servers configured to host a database or a data store application and provide data requested from the hosted database to client-computers or other server-computers. A database application may be a relational database or any other suitable type of data store (e.g., a data warehouse, a data lake, etc.). User device 120 may be a smart phone, a tablet computer, a laptop computer, or any electronic device (e.g., a mobile application) that is capable of storing and executing a computer application (e.g., a mobile application).

In accordance with aspects, issuing organization backend infrastructure 101 may include a private network that facilitates operative communication among systems components included therein. Additionally, issuing organization backend infrastructure 101 may be configured to interface with a public network, such as the internet, in order to facilitate communications with hardware and software components that are outside of issuing organization backend infrastructure 101.

The components of FIG. 1 may each be communicatively coupled to public and private networks with appropriate hardware and software. For instance, user device 120 may include a wired or wireless network interface card (NIC) that interfaces with a public network, such as the internet, and is configured with appropriate communication protocols. Likewise, transaction management server 105, communications server 115, access control server 175, and the database server components of FIG. 1 may include hardware (NICs, switches, routers, etc.) configured with appropriate protocols for intercommunication with each other across public and private networks.

At the application layer, the various components of FIG. 1 may be configured to communicate via any suitable method. For instance, communication may be configured via various application programming interfaces (APIs). APIs may be internal APIs (i.e., only accessible within the bounds of a private communication network), or they may be external facing APIs. An external API gateway may be a partner API that requires access rights from form the providing party in order to gain access. An external API gateway may be accessible to partner organizations via a public network (e.g., the internet). APIs, whether internal or external, may be based on any suitable API architecture. Exemplary API architectures and/or protocols include SOAP (Simple Object Access Protocol), XML-RPC, REST (Representational State Transfer), or the like.

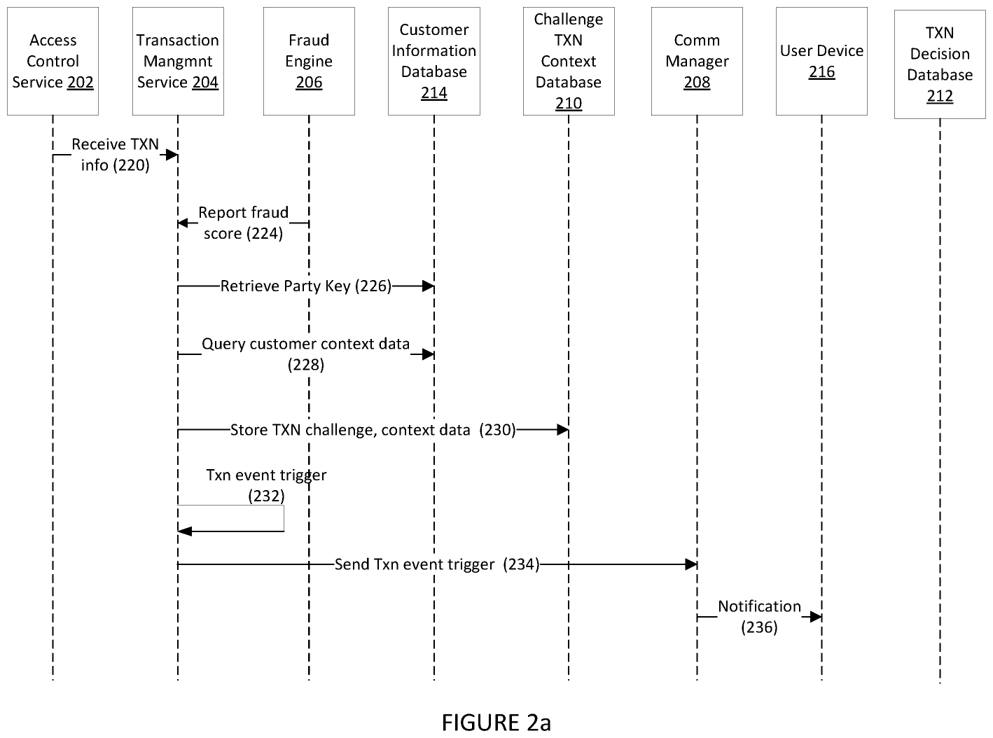

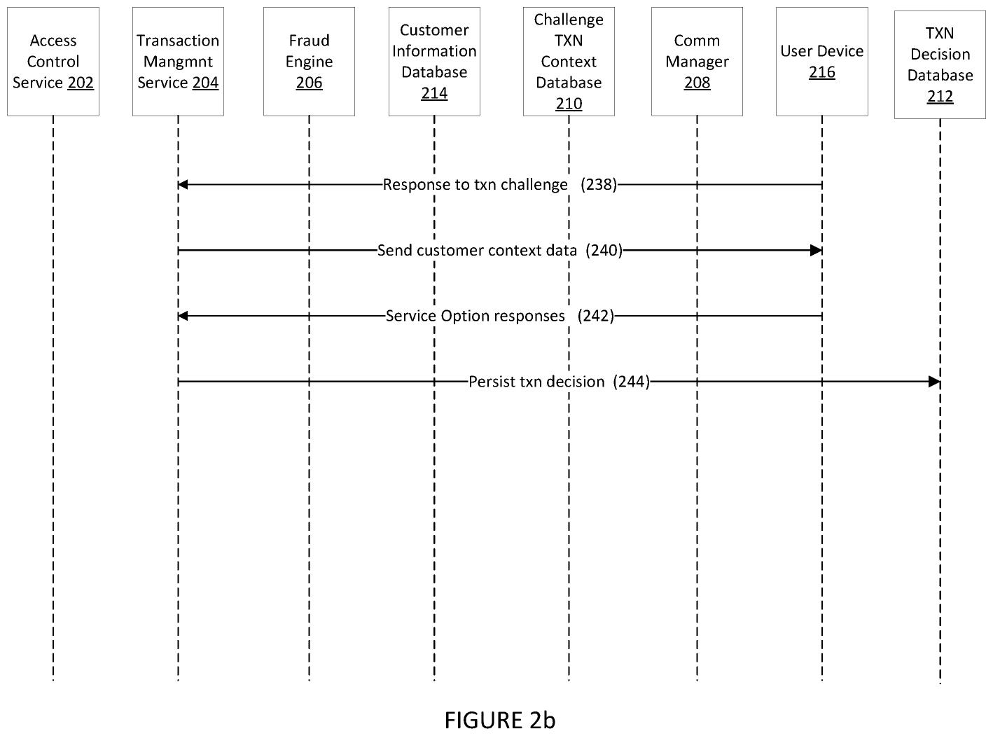

FIG. 2a and FIG. 2b are sequence diagrams for providing application-based management of transactions, in accordance with aspects. At step 220 of FIG. 2a, transaction management service 204 receives transaction information from access control service 202. The received transaction information may include a set of defined data parameters that define the transaction. These data parameters may be defined, e.g., as part of an API defined for use with the access control service provided by the payment processing organization. The received transaction information may include a transaction identifier (a “transaction ID) that uniquely identifies the transaction, a credit card/account number that identifies the payment product used in the transaction, a merchant identifier (a “merchant ID”) that uniquely identifies the merchant with which the transaction was undertaken, the name of the merchant with which the transaction was undertook, etc.

At step 222 of FIG. 2a, the received transaction may be processed by fraud engine 206. Fraud engine 206 may include a machine learning algorithm that has been trained to detect fraudulent transactions. Fraud engine 206 may indicate to transaction management service 204 in step 224 that the received transaction is predicted to be fraudulent or has a high probability of being a fraudulent transaction.

At step 226, transaction management service 204 may retrieve a party key from customer information database 214. The party key is a unique identifier of the customer of the issuing organization that is associated with the received transaction (the “initiating customer”). One or more of the data parameters received from the access control service with respect to the received transaction may be use as a lookup key to identify the initiating customer in customer information database 214. For instance, an account number of the payment product associated with the received transaction may be used to determine a party key. Customer information database 214 may return the party key to transaction management service 204. Transaction management service 204 may then use the party key to query customer context data from customer information database 214.

At step 230 of FIG. 2a, a transaction challenge ID is generated, transaction context data is retrieved based on the received transaction, and the challenge ID and transaction context are stored in challenge transaction context database 210. The party key may be stored as part of the transaction context data. At step 232, the stored transaction context data is used to generate a transaction event trigger. At step 234, the transaction event trigger is sent to the communication manager 208. At step 236, comm manager 208 formats a notification and sends the notification to user device 216. The notification may be formatted as noted, above, and may include the challenge ID and other transaction context data. In some aspects, the notification may include customer context data. The notification may include, or prompt, a transaction challenge that requests the initiating user to validate the received transaction.

With reference to FIG. 2b, at step 238 a response to the transaction challenge is received by transaction management service 204 from user device 216. The response may include the challenge ID, and other embedded parameters, such as the party key, a transaction ID, etc. The embedded parameters may be used as lookup parameters to verify the received challenge ID matches the corresponding challenge ID stored in challenge transaction context database 210. At step 240, if customer context data was not sent (or fully sent) to user device 216 in step 234 (i.e., included in the transaction trigger event data), then customer context data may be queried and sent to user device 216 at step 240. Customer context data may be retrieved using the party key as a lookup parameter in a database query.

At step 242 of FIG. 2b, service option responses may be received from user device 216 by transaction management service 204, and may be applied with respect to the various accounts as communicated by the initiating customer. At step 244, transaction management service 204 may persist the transaction decision to transaction decision database 212. At step 246, data from transaction decision database 212 may be used to continually train ML models used in fraud engine 206.

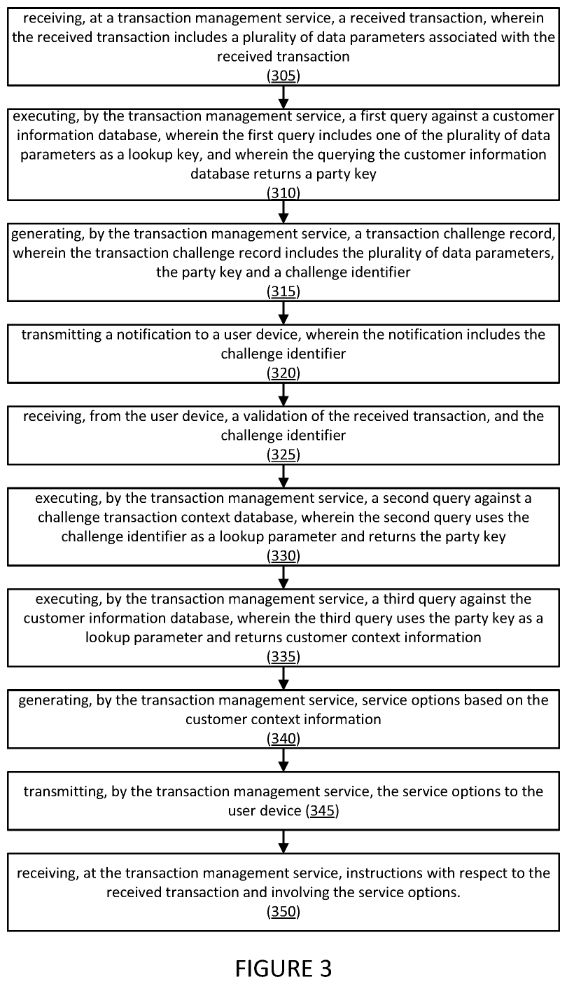

FIG. 3 is a flow chart for providing application-based management of transactions, in accordance with aspects. Step 305 includes receiving, at a transaction management service, a received transaction, wherein the received transaction includes a plurality of data parameters associated with the received transaction.

Step 310 incudes executing, by the transaction management service, a first query against a customer information database, wherein the first query includes one of the plurality of data parameters as a lookup key, and wherein the querying the customer information database returns a party key.

Step 315 includes generating, by the transaction management service, a transaction challenge record, wherein the transaction challenge record includes the plurality of data parameters, the party key and a challenge identifier.

Step 320 includes transmitting a notification to a user device, wherein the notification includes the challenge identifier.

Step 325 includes receiving, from the user device, a validation of the received transaction, and the challenge identifier.

Step 330 includes executing, by the transaction management service, a second query against a challenge transaction context database, wherein the second query uses the challenge identifier as a lookup parameter and returns the party key.

Step 335 includes executing, by the transaction management service, a third query against the customer information database, wherein the third query uses the party key as a lookup parameter and returns customer context information.

Step 340 includes generating, by the transaction management service, service options based on the customer context information.

Step 345 includes transmitting, by the transaction management service, the service options to the user device.

Step 350 includes receiving, at the transaction management service, instructions with respect to the received transaction and involving the service options.

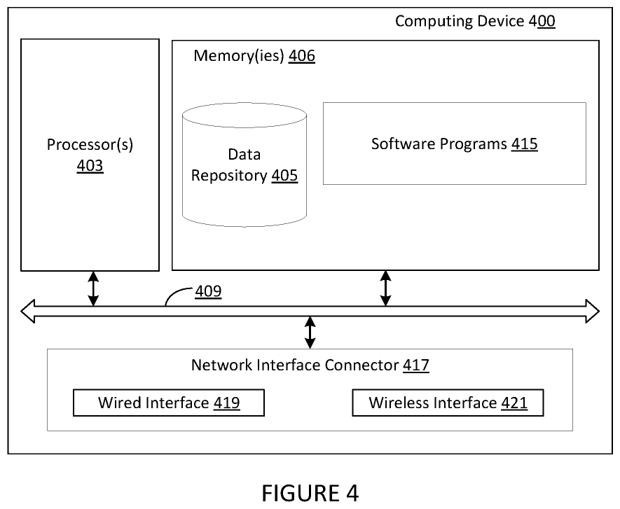

FIG. 4 is a block diagram of a computing device for implementing certain aspects of the present disclosure. FIG. 4 depicts exemplary computing device 400. Computing device 400 may represent the system components described herein. For example, system components such as a transaction management server, an access control server, a communications server, a fraud detection and prevention server, and database servers may include components and configurations like, or similar to, computing device 400. Computing device 400 includes a processor 403 coupled to a memory 406. Memory 406 may include volatile memory. The processor 403 executes computer-executable program code stored in memory 406, such as software programs 415. Software programs 415 may include one or more of the logical steps disclosed herein as a programmatic instruction, which can be executed by processor 403. Memory 406 may also include data repository 405, which may be nonvolatile memory for data persistence. The processor 403 and the memory 406 may be coupled by a bus 409. In some examples, the bus 409 may also be coupled to one or more network interface connectors 417, such as wired network interface 419, and/or wireless network interface 421. Computing device 400 may also have user interface components, such as a screen for displaying graphical user interfaces and receiving input from the user, a mouse, a keyboard and/or other input/output components (not shown).

The various processing steps and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a micro-processor and/or in the form of statically programmed electronic circuitry.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one aspect, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, aspects of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications or equivalent arrangements.

1. A method comprising:
receiving, at a transaction management service, a received transaction, wherein the received transaction includes a plurality of data parameters associated with the received transaction;
generating, by the transaction management service, a transaction challenge record, wherein the transaction challenge record includes the plurality of data parameters, a party key and a challenge identifier;
transmitting a notification to a user device, wherein the notification includes the challenge identifier;
receiving, from the user device, a validation communication, wherein the validation communication validates the received transaction and includes the challenge identifier;
determining customer context information based on the challenge identifier and the party key;
generating, by the transaction management service, service options based on the customer context information;
transmitting, by the transaction management service, the service options to the user device; and
receiving, at the transaction management service, instructions with respect to the received transaction based on the service options.

2. The method of claim 1, comprising:
executing, by the transaction management service, a first query against a customer information database, wherein the first query includes one of the plurality of data parameters as a lookup key, and wherein the first query returns the party key.

3. The method of claim 2, comprising:
persisting the transaction challenge record in a challenge transaction context database.

4. The method of claim 3, comprising:
executing, by the transaction management service, a second query against the challenge transaction context database, wherein the second query uses the challenge identifier as a lookup parameter and returns the party key.

5. The method of claim 2, comprising:
executing, by the transaction management service, a third query against the customer information database, wherein the third query uses the party key as a lookup parameter and returns customer context information.

6. The method of claim 1, wherein the received transaction is processed by a fraud engine and wherein the fraud engine returns a fraud score to the transaction management service.

7. The method of claim 1, comprising:
generating, by the transaction management service, a transaction event trigger, wherein the transaction event trigger is based on the transaction challenge record.

8. The method of claim 7, wherein the transaction challenge record and the transaction event trigger include a template ID.

9. The method of claim 8, wherein the transaction management service transmits the transaction event trigger to a communication manager.

10. The method of claim 9, wherein the communication manager formats the notification as specified by the template ID.

11. A system, comprising:
a transaction management server executing a transaction management service, wherein the transaction management service is configured to:
receive a received transaction, wherein the received transaction includes a plurality of data parameters associated with the received transaction;
generate a transaction challenge record, wherein the transaction challenge record includes the plurality of data parameters, a party key and a challenge identifier;
transmit a notification to a user device, wherein the notification includes the challenge identifier;
receive, from the user device, a validation communication, wherein the validation communication validates the received transaction and includes the challenge identifier;
determine customer context information based on the challenge identifier and the party key;
generate service options based on the customer context information;
transmit the service options to the user device; and
receive instructions with respect to the received transaction based on the service options.

12. The system of claim 11, wherein the transaction management service is configured to execute a first query against a customer information database, wherein the first query includes one of the plurality of data parameters as a lookup key, and wherein the first query returns the party key.

13. The system of claim 12, wherein the transaction management service is configured to persist the transaction challenge record in a challenge transaction context database.

14. The system of claim 13, wherein the transaction management service is configured to execute a second query against the challenge transaction context database, wherein the second query uses the challenge identifier as a lookup parameter and returns the party key.

15. The system of claim 12, wherein the transaction management service is configured to execute a third query against the customer information database, wherein the third query uses the party key as a lookup parameter and returns customer context information.

16. A non-transitory computer readable storage medium, including instructions stored thereon for facilitating application-based management of transactions, which when read and executed by one or more computers cause the one or more computers to perform steps comprising:
receiving, at a transaction management service, a received transaction, wherein the received transaction includes a plurality of data parameters associated with the received transaction;
generating, by the transaction management service, a transaction challenge record, wherein the transaction challenge record includes the plurality of data parameters, a party key and a challenge identifier;
transmitting a notification to a user device, wherein the notification includes the challenge identifier;
receiving, from the user device, a validation communication, wherein the validation communication validates the received transaction and includes the challenge identifier;
determining customer context information based on the challenge identifier and the party key;
generating, by the transaction management service, service options based on the customer context information;
transmitting, by the transaction management service, the service options to the user device; and
receiving, at the transaction management service, instructions with respect to the received transaction based on the service options.

17. The non-transitory computer readable storage medium of claim 16, comprising the steps of:
executing, by the transaction management service, a first query against a customer information database, wherein the first query includes one of the plurality of data parameters as a lookup key, and wherein the first query returns the party key.

18. The non-transitory computer readable storage medium of claim 17, comprising the steps of:
persisting the transaction challenge record in a challenge transaction context database.

19. The non-transitory computer readable storage medium of claim 18, comprising the steps of:
executing, by the transaction management service, a second query against the challenge transaction context database, wherein the second query uses the challenge identifier as a lookup parameter and returns the party key.

20. The non-transitory computer readable storage medium of claim 17 comprising the steps of:
executing, by the transaction management service, a third query against the customer information database, wherein the third query uses the party key as a lookup parameter and returns customer context information.
